(19) United States
(12) Patent Application Publication
(10) Pub. No.: US 2009/0103723 A1
(43) Pub. Date: Apr. 23, 2009

(54) System And Method For Secure Storage Of Data

(75) Inventors: Charles R. Martin, Louisville, CO (US); Carl T. Madison, Louisville, CO (US)

Correspondence Address: OSHA LIANG L.L.P./SUN, TWO HOUSTON CENTER, 909 FANNIN, SUITE 3500, HOUSTON, TX, 77010, US

(73) Assignee: Sun Microsystems, Inc., Santa Clara, CA (US)

(21) Appl. No.: 11/875,715

(22) Filed: Oct. 19, 2007

(51) Int. Cl. H04L 9/06; H03M 99/00

(52) U.S. Cl. 380/44; 341/95

(57) ABSTRACT

A method of securely storing a data item including obtaining the data item; translating the data item into a first plurality of data blocks using an erasure code associated with a rate; and storing at least a subset of the first plurality of data blocks, where a size of the subset exceeds a product of the rate and a size of the first plurality of data blocks.

### BACKGROUND

Encryption may be used to protect sensitive data. During encryption, the sensitive data is transformed into an encrypted form from which there is a very low probability of assigning meaning. In other words, the sensitive data becomes unintelligible to anyone and/or any machine unauthorized to access it. Accordingly, encryption has many uses both on a single machine and in all types of networks linking multiple machines.

Encryption often requires the use of an encrypting algorithm and one or more encryption keys. The encryption algorithm and the encryption keys work together to encode the sensitive data and, at a future time, decode (i.e., decrypt) the sensitive data. The encryption keys may be of any length required by the encryption algorithm. As the encryption keys are of paramount importance during the encryption process and decryption process, the encryption keys should be protected from unauthorized individuals and machines. Accordingly, the encryption keys should never appear as clear text outside of a secure environment.

### SUMMARY

A method of securely storing a data item including obtaining the data item; translating the data item into a first plurality of data blocks using an erasure code associated with a rate; and storing at least a subset of the first plurality of data blocks, where a size of the subset exceeds a product of the rate and a size of the first plurality of data blocks.

A computer readable medium storing instructions to securely store a data item, the instructions including functionality to obtain the data item; translate the data item into a first plurality of data blocks using an erasure code associated with a rate; and store at least a subset of the first plurality of data blocks, wherein a size of the subset exceeds a product of the rate and a size of the first plurality of data blocks.

A system for securely storing a data item including a translation module configured to translate the data item into a first plurality of data blocks using an erasure code associated with a rate; and a plurality of storage devices operatively connected to the translation module and configured to store at least a subset of the first plurality of data blocks, wherein a size of the subset exceeds a product of the rate and a size of the first plurality of data blocks.

Other aspects of the invention will be apparent from the following description and the appended claims.

### BRIEF DESCRIPTION OF DRAWINGS

FIG. 1 shows a system in accordance with one or more embodiments of the invention.

FIG. 2 and FIG. 3 show flowcharts in accordance with one or more embodiments of the invention.

FIG. 4 shows an example in accordance with one or more embodiments of the invention.

FIG. 5 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a system and method for securely storing data. More specifically, embodiments of the invention provide a system and method for securely storing a data item by applying an erasure code to the data item and storing one or more of the resulting N data blocks. The data item may be recovered from a subset of the N data blocks.

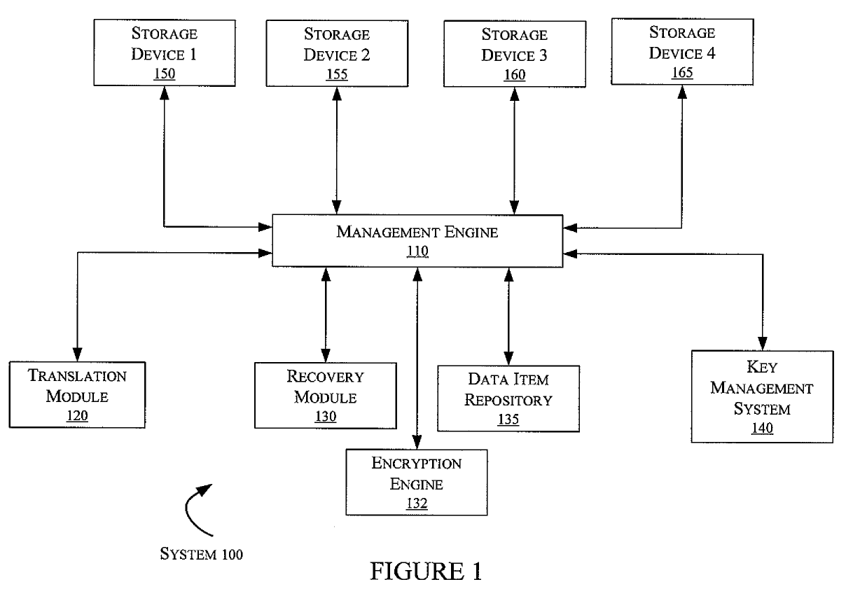

FIG. 1 shows a system (100) in accordance with one or more embodiments of the invention. As shown in FIG. 1, the system (100) has numerous components including a management engine (110), a translation module (120), a recovery module (130), an encryption engine (132), a data item repository (135), a key management station (KMS) (140), and multiple storage devices (i.e., Storage Device 1 (150), Storage Device 2 (155), Storage Device 3 (160), Storage Device 4 (165)). These components are described below and may be located on the same device (e.g., a server, mainframe, desktop PC, laptop, PDA, television, cable box, satellite box, kiosk, telephone, mobile phone, etc.) or may be located on separate devices connected by a network (e.g., the Internet), with wired and/or wireless segments.

In one or more embodiments of the invention, the multiple storage devices (e.g., Storage Device 1 (150), Storage Device 2 (155), Storage Device 3 (160), Storage Device 4 (165)) are responsible for storing data. Each storage device may have a processor, volatile memory, non-volatile memory, and/or a storage medium (e.g., hard disk, optical disk, tape, microelectromechanical systems, etc.) to store the data. In order to protect stored data, each of the multiple storage devices may require authentication (e.g., via passwords, biometric authentication, etc.) prior to granting access to the stored data.

In one or more embodiments of the invention, the multiple storage devices (i.e., Storage Device 1 (150), Storage Device 2 (155), Storage Device 3 (160), Storage Device 4 (165)) are geographically isolated from each other. In other words, one or more of the multiple storage devices may be located in different buildings, in different cities, in different states, etc. In one or more embodiments of the invention, the multiple storage devices are located in the same facility.

In one or more embodiments of the invention, the data item repository (135) stores one or more data items. A data item may include, for example, a document, an image, a spreadsheet, an email, a database, a motion picture, an application, a file, etc. A data item stored in the data item repository (135) may be stored in an encrypted format (i.e., cipher text) or a decrypted format (i.e., clear text). In one or more embodiments of the invention, the data item repository (135) is a database, a flat file, or any other type of datastore. New data items may be added to the data item repository (135) and existing data items may be modified or deleted from the data item repository (135).

In one or more embodiments of the invention, the key management station (KMS) (140) is configured to generate one or more encryption key of any size (e.g., 80 bits, 128 bits, 3072 bits, etc.). The KMS (140) may include a random number generator (not shown) for use in generating an encryption key. KMS (140) may also be configured to revoke and/or update existing encryption keys. In one or more embodiments of the invention, the KMS (140) is used to record the encryption key used to encrypt a given data item (e.g., a data item stored in the data item repository (135)). In one or more embodiments of the invention, the encryption key itself is considered a data item. Accordingly, an encryption key may be stored in the data item repository (135) (discussed above)

In one or more embodiments of the invention, the encryption engine (132) is used to encrypt and/or decrypt one or more data items using an encryption key. The data items to be encrypted by the encryption engine (132) may be stored in the data item repository (135). Similarly, the already encrypted data items may also be stored in the data item repository (135). The one or more encryption keys used for encrypting and/or decrypting the data items may be provided by the KMS (140). The encryption engine (132) may use any known algorithm to perform the encryption and/or decryption (e.g., Blowfish, RC4, RC5, AES, etc.).

In one or more embodiments of the invention, the translation module (120) stores any number of algorithms to implement one or more erasure codes. An (N, K) erasure code encodes K data blocks into N>K blocks. Reconstruction of the original K blocks depends on the type of erasure code in use (e.g., optimal erasure code, suboptimal erasure code). In the case of optimal erasure codes, any unique K blocks of the N blocks may be used to reconstruct the original K data blocks. In the case of suboptimal erasure codes, any unique (1+ε)·K blocks of the N blocks may be used to reconstruct the original K data blocks, where ε≧0 is a property of the erasure code in use. The rate R of the (N, K) erasure code is expressed as R=K/N, and the storage overhead S of the (N, K) erasure code is expressed as S=1/R=N/K. Example erasure codes include Reed-Solomon codes, Tornado codes, Luby Transform codes, Raptor codes, etc. New algorithms and new erasure codes may be added to the translation module (120), while existing algorithms may be modified and/or deleted.

In one or more embodiments of the invention, the translation module is configured to translate a data item (e.g., a file, an application, an encryption key, etc.) into N data blocks using an erasure code. The data item may first be partitioned into K data blocks, and then encoded into N data blocks using the erasure code. Each of the K data blocks may be identical in size (e.g., 8 bits, 10 bits, 32 bits, 128 bits, etc.). In one or more embodiments of the invention, each of the N data blocks or at least K of the N data blocks are stored on one or more storage devices (i.e., Storage Device 1 (150), Storage Device 2 (155), Storage Device 3 (160), Storage Device 4 (165)).

In one or more embodiments of the invention, the recovery module (130) is configured to reconstruct the data item from a subset of the N data blocks. As discussed above, the size of the subset required to reconstruct the data item depends on the type of erasure code in use.

In one or more embodiments of the invention, the management engine (110) is used to manage the translation module (120), the recovery module (130), the encryption engine (132), the data item repository (135), the KMS (140), and the multiple storage devices (150, 155, 160, 165). In other words, the management engine (110) provides an interface to the translation module (120), the recovery module (130), the encryption engine (132), the data item repository (135), the KMS (140), and the multiple storage devices (i.e., Storage Device 1 (150), Storage Device 2 (155), Storage Device 3 (160), Storage Device 4 (165)). In one or more embodiments of the invention, for a given data item, the management engine (110) records the erasure code used to translate the data item into N blocks and/or the storage locations of one or more of the N blocks. The management engine (110) may also provide a user with access to the system (100) via, for example, a graphical user interface (GUI). Accordingly, the management engine (110) may accept input (e.g., keyboard input, cursor input, voice commands, etc.) from the user and produce outputs (e.g., on a display screen, printer, audio speakers, etc.).

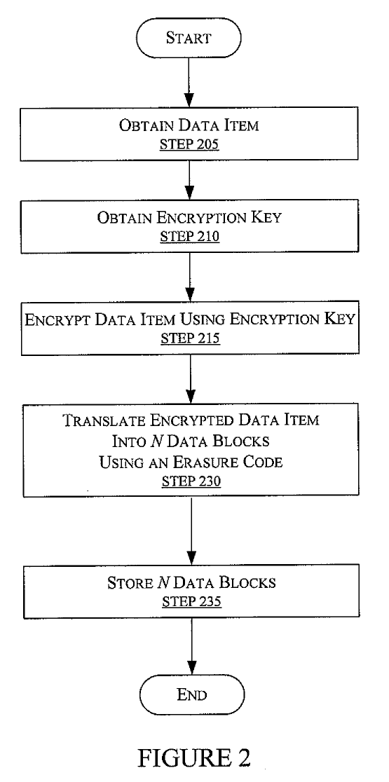

FIG. 2 shows a flowchart in accordance with one or more embodiments of the invention. The process shown in FIG. 2 may be used to securely store a data item. Those skilled in the art, having the benefit of this detailed description, will appreciate that the order and number of steps shown in FIG. 2 may differ among embodiments of the invention.

Initially, a data item is obtained (STEP 205). The obtained data item may be a document, an image, a spreadsheet, a database, a motion picture, an application, a file, etc. The data item may be obtained from a repository (i.e., data item repository (135), discussed above in reference to FIG. 1).

In STEP 210, an encryption key is obtained. The obtained encryption key may be a newly generated encryption key (Le., via the KMS (140), discussed above in reference to FIG. 1) or may be a previously used encryption key. The encryption key may be of any size (e.g., 80 bits, 128 bits, 3072 bits, etc.) and should contain sufficient entropy to make guessing the encryption key infeasible.

In STEP 215, the obtained encryption key is used to encrypt the obtained data item. The encryption process may use asymmetric encryption or symmetric encryption. Any appropriate algorithm may be used with the encryption key to encrypt the data item.

In STEP 230, the encrypted data item is translated into N data blocks using an erasure code. As discussed above, an erasure code may first partition the encrypted data item into K data blocks, and then encode the K data blocks into N>K data blocks. The erasure code used to translate the encrypted data item may be of any type (e.g., Tornado codes, Luby Transform codes, Raptor codes, etc.).

In STEP 235, the N data blocks are stored. In one or more of the embodiments, the N data blocks are stored on one or more storage devices (i.e., Storage Device 1 (150), Storage Device 2 (155), Storage Device 3 (160), Storage Device 4 (165), discussed above in reference to FIG. 1). Each of the N data blocks may be stored on separate storage devices. Alternatively, all or some of the N data blocks may be stored on the same storage device. The storage devices may implement additional access restrictions (e.g., password, biometrics, etc.) to protect the stored data blocks.

Still referring to STEP 235, in one or more embodiments of the invention, less than N but at least K data blocks are stored when using an optimal erasure code. In other words, when using an optimal erasure code, the number of data blocks stored must be greater than or equal to the product of the erasure code's rate and the total number of data blocks following application of the erasure code (i.e., N data blocks). Similarly, in the case of suboptimal erasure codes, less than N but at least (1+ε)·K data blocks are stored. In other words, when using a suboptimal erasure code, the number of data blocks stored is greater than the product of the erasure code's rate and the total number of data blocks following application of the erasure code (i.e., N data blocks).

Although the steps in FIG. 2 have been described from a system perspective, those skilled in the art, having the benefit of this detailed description, will appreciate the user perspective essentially mirrors the steps shown in FIG. 2. For example, in STEP 205, the system obtains a data item. In contrast, the user may select or provide the data item. Similarly, the user may select or provide an encryption key to encrypt the data item, the user may select or provide an erasure code, the user may select or provide the storage locations for the N data blocks, etc.

In addition, although the process shown in FIG. 2 includes encrypting the data item prior to translating the data item using an erasure code, those skilled in the art, having the benefit of this detailed description, will appreciate that encryption of the data item is optional. In other words, in one or more embodiments of the invention, the obtained data item is not encrypted prior to application of the erasure code (i.e., in STEP 230 the non-encrypted data item is translated using the erasure code). In such embodiments, STEP 210 and STEP 215 are omitted.

As discussed above, an encryption key may be considered a data item. Accordingly, in one or more embodiments of the invention, the process shown in FIG. 2 is used to securely store the encryption key. In such embodiments, STEP 230 effectively translates the encryption key into N data blocks using an erasure code, while STEP 205 and STEP 215 are omitted. The encryption key may be combined with metadata prior to application of the erasure code.

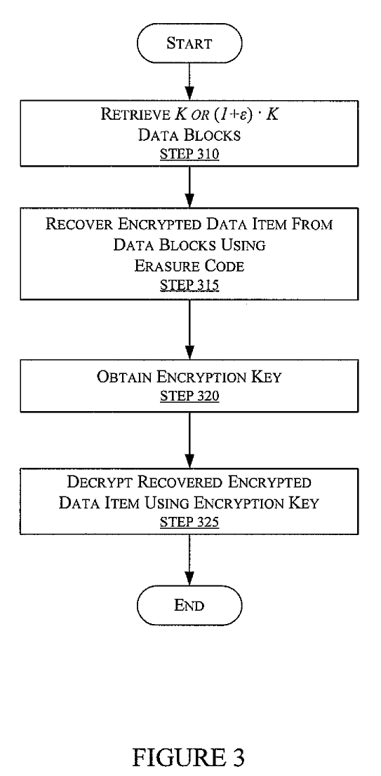

FIG. 3 shows a flowchart in accordance with one or more embodiments of the invention. The process shown in FIG. 3 may be used to recover a data item following application of an erasure code to the data item. The process shown in FIG. 3 may further be used to decrypt data items that have been encrypted by an encryption key. Those skilled in the art, having the benefit of this detailed description, will appreciate that the order and number of steps shown in FIG. 3 may differ among embodiments of the invention.

Initially, K or (1+ε)·K of the N data blocks are retrieved (STEP 310). The number of data blocks retrieved depends on the type of erasure code used to generate the N data blocks (discussed above). In one or more embodiments of the invention, the K or (1+ε)·K data blocks may be stored on one or more storage devices. The storage devices may require authentication (e.g., passwords, biometrics, etc.) prior to granting access to the data stored within the data devices. Further, additional tests may be run on each retrieved data block to determine whether the data block has been corrupted.

In STEP 315, the encrypted data item is recovered by applying the erasure code algorithm to the retrieved data blocks. As discussed above, in order to recover the encrypted data item from the N data blocks generated by the erasure code, at most K or (1+ε)·K of the N data blocks, depending on the type of erasure code used, are required. In other words, when using an optimal erasure code, the number of data blocks retrieved must be equal to or greater than the product of the erasure code's rate and the total number of data blocks following application of the erasure code (i.e., N data blocks). Similarly, when using a suboptimal erasure code, the number of data blocks retrieved must exceed the product of the erasure code's rate and the total number of data blocks following an application of the erasure code (i.e., N data blocks). In the event that an excess of data blocks has been retrieved, the excess number of data blocks (i.e. the data blocks in addition to K or (1+ε)·K) may be discarded.

In STEP 320, an encryption key is obtained. The encryption key may be identical or trivially related to the encryption key originally used to encrypt the data item (i.e., the encryption process used a symmetric-key algorithm). Alternatively, the obtained encryption key may be different than the encryption key used to encrypt the data item (i.e., the encryption process used an asymmetric-key algorithm).

In STEP 325, the encrypted data item is decrypted using the encryption key. The resulting (i.e., clear text) data item may then be stored and/or transmitted.

Although the steps in FIG. 3 have been described from a system perspective, those skilled in the art, having the benefit of this detailed description, will appreciate the user perspective essentially mirrors the steps shown in FIG. 3. For example, in STEP 310, the system retrieves data blocks. In contrast, the user may provide the data blocks. Similarly, the user may provide an encryption key to decrypt a recovered, encrypted data item.

In addition, although the process shown in FIG. 3 includes decrypting the data item after recovering the encrypted data item, those skilled in the art, having the benefit of this detailed description, will appreciate that encryption of the data item is optional. In other words, in one or more embodiments of the invention, as the data item was not encrypted prior to applying the erasure code, the retrieved data item is also in clear text format (i.e., not encrypted). In such embodiments, the non-encrypted data item is recovered using the erasure code (STEP 315), and STEP 320 and STEP 325 are omitted.

As discussed above, an encryption key may be considered a data item. Accordingly, in one or more embodiments of the invention, the process shown in FIG. 3 is used to recover a securely stored encryption key. In such embodiments, STEP 315 effectively recovers the securely stored encryption key from the retrieved data blocks, while STEPS 320 and STEP 325 are omitted. Any metadata originally combined with the encryption key may be extracted once the encryption key is recovered.

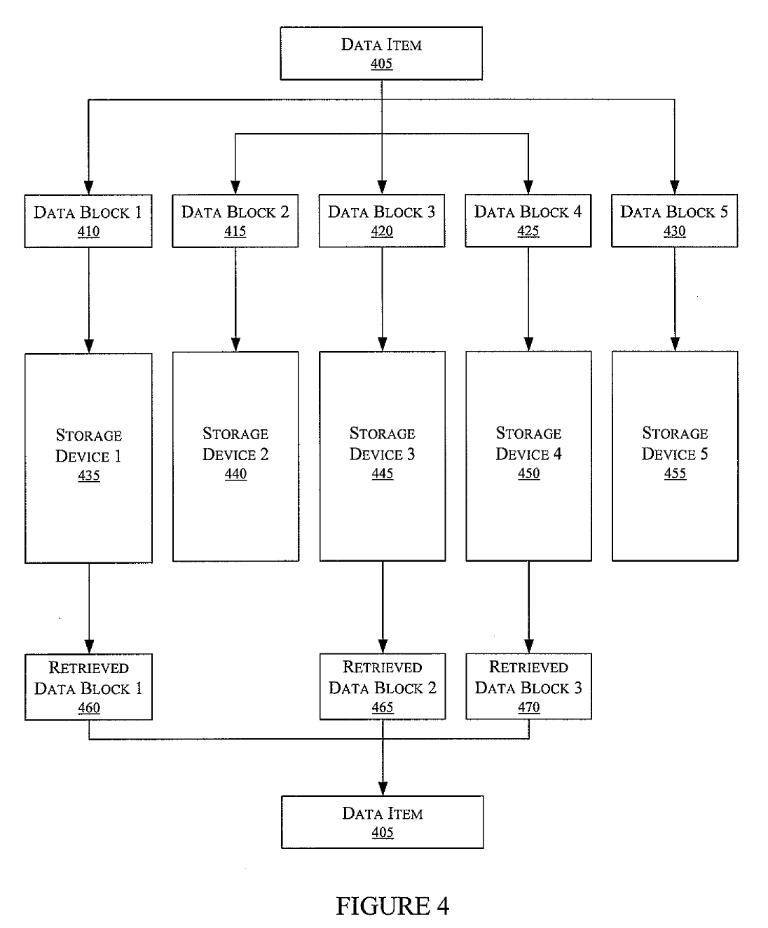

FIG. 4 shows an example in accordance with one or more embodiments of the invention. In this example, an optimal erasure code generating five data blocks (i.e., N=5) with a rate of 3/5 (i.e., R=3/5 and K=R×N=3) is assumed. As shown in FIG. 4, a data item (405) is translated into five data blocks (i.e., Data Block 1 (410), Data Block 2 (415), Data Block 3 (420), Data Block 4 (425), Data Block 5 (430)) using the erasure code. Each of the five data blocks (410, 415, 420, 425, 430) are stored in separate storage devices (i.e. Storage Device 1 (435), Storage Device 2 (440), Storage Device 3 (445), Storage Device 4 (450), and Storage Device 5 (455)). The storage devices may be geographically isolated from each other.

At a future time, it may be desirable to recover the data item (405) now securely stored as five stored data blocks (410, 415, 420, 425, 430). As the erasure code is optimal, only three of the five data blocks are needed for successful recovery of the data item.

As shown in FIG. 4, the retrieved data block 1 (460) is retrieved from the storage device 1 (435), the retrieved data block 2 (465) is retrieved from the storage device 3 (445), and the retrieved data block 3 (470) is retrieved from the storage device 4 (450). The retrieved data block 1 (460) is essentially the same as data block (410). Similarly, the retrieved data block 2 (465) is essentially the same as the data block 3 (420). Further still, the retrieved data block 3 (470) is essentially the same as the data block 4 (425). With the three retrieved data blocks (460, 465, 470) and the erasure code, it is possible to recover the data item (405).

Although the example shown in FIG. 4 uses the retrieved data blocks (460, 465, 470) from the storage device 1 (435), the storage device 3 (445), and the storage device 4 (450), those skilled in the art, having the benefit of this detailed description will appreciate that three data blocks retrieved from any of the storage devices could also be used to recover the encryption key.

Those skilled in the art, having the benefit of this detailed description, will appreciate that the translated data item is highly secure. Specifically, by translating the encryption key into multiple data blocks and storing at least K or (1+ε)·K of the multiple blocks on separate storage devices, K or (1+ε)·K different storage devices must be compromised before any attempt can be made to recover the data item.

Those skilled in the art, having the benefit of this detailed description, will appreciate that by translating the data item into N data blocks using an optimal erasure code with a rate of R=K/N, and storing all N data blocks, the data item is only lost if N−K+1 or more data blocks are corrupted or destroyed. Further, assuming all N data blocks are stored on separate storage devices and each storage device has an exponential failure rate λ, the overall mean time to failure will be λ^{-(N-K+1)}.

Those skilled in the art, having the benefit of this detailed description, will appreciate one or more embodiments of the invention are highly scalable through selection of an appropriate erasure code.

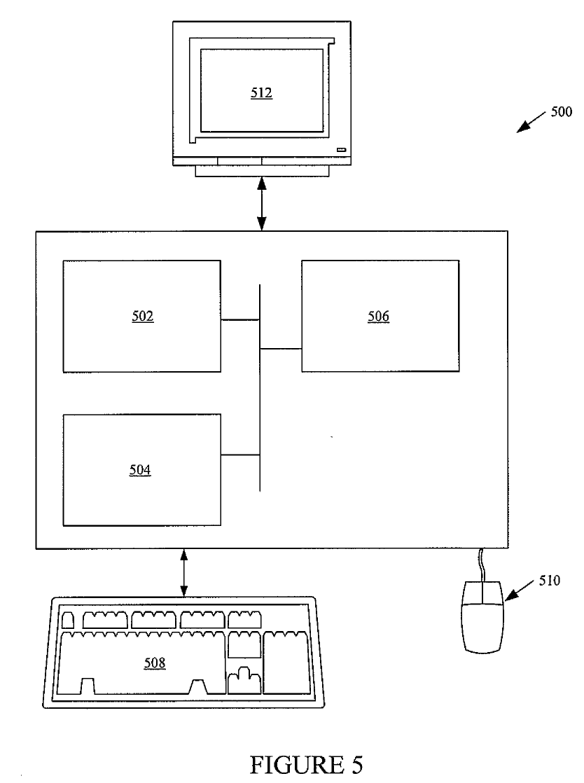

Embodiments of the invention may be implemented on virtually any type of computer regardless of the platform being used. For example, as shown in FIG. 5, a computer system (500) includes a processor (502), associated memory (504), a storage device (506), and numerous other elements and functionalities typical of today's computers (not shown), The computer (500) may also include input means, such as a keyboard (508) and a mouse (510), and output means, such as a monitor (512). The computer system (500) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (500) may be located at a remote location and connected to the other elements over a network. Further, embodiments of the invention may be implemented on a distributed system having a plurality of nodes, where each portion of the invention (e.g., translation module, recovery module, etc.) may be located on a different node within the distributed system. In one or more embodiments of the invention, the node is a computer system. In one or more embodiments of the invention, the node is a processor with associated physical memory. In one or more embodiments of the invention, the node may also be a processor with shared memory and/or resources. Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of securely storing a data item comprising:
obtaining the data item;
translating the data item into a first plurality of data blocks using an erasure code associated with a rate; and
storing at least a subset of the first plurality of data blocks, wherein a size of the subset exceeds a product of the rate and a size of the first plurality of data blocks.

2. The method of claim 1, wherein translating the data item comprises partitioning the data item based on the erasure code prior to applying the erasure code.

3. The method of claim 1, wherein each data block in the subset is stored on a separate storage device.

4. The method of claim 1, wherein the erasure code is at least one selected from a group consisting of a suboptimal erasure code and an optimal erasure code.

5. The method of claim 1, further comprising:
combining the data item with metadata prior to encoding the first plurality of data blocks, wherein the data item is an encryption key.

6. The method of claim 1, further comprising:
retrieving a second plurality of data blocks from the subset after storing at least the subset, wherein a size of the second plurality of data blocks equals the product; and
recovering the data item from the second plurality of data blocks using the erasure code.

7. The method of claim 1, further comprising:
retrieving a second plurality of data blocks from the subset after storing at least the subset wherein a size of the second plurality of data blocks exceeds the product; and
recovering the data item from the second plurality of data blocks using the erasure code.

8. The method of claim 6, further comprising:
using an encryption key to perform at least one selected from a group consisting of encrypting the data item prior to translating the data item and decrypting the data item after recovering the data item.

9. A computer readable medium storing instructions to securely store a data item, the instructions comprising functionality to:
obtain the data item;
translate the data item into a first plurality of data blocks using an erasure code associated with a rate; and
store at least a subset of the first plurality of data blocks, wherein a size of the subset exceeds a product of the rate and a size of the first plurality of data blocks.

10. The computer readable medium of claim 9, wherein the instructions for translating the data item further comprise functionality to partition the data item based on the erasure code prior to applying the erasure code.

11. The computer readable medium of claim 9, the instructions further comprising functionality to:
combine the data item with metadata prior to encoding the first plurality of data blocks, wherein the data item is an encryption key.

12. The computer readable medium of claim 9, wherein each data block in the subset is stored on a separate storage device.

13. The computer readable medium of claim 9, wherein the subset of the plurality of data blocks is retrieved from at least one of the plurality of storage devices.

14. The computer readable medium of claim 9, further comprising:
retrieving a second plurality of data blocks from the subset after storing at least the subset, wherein a size of the second plurality of data blocks equals the product; and
recovering the data item from the second plurality of data blocks using the erasure code.

15. The computer readable medium of claim 9, further comprising:
retrieving a second plurality of data blocks from the subset after storing at least the subset, wherein a size of the second plurality of data blocks exceeds the product; and
recovering the data item from the second plurality of data blocks using the erasure code.

16. A system for securely storing a data item comprising:
a translation module configured to translate the data item into a first plurality of data blocks using an erasure code associated with a rate; and
a plurality of storage devices operatively connected to the translation module and configured to store at least a subset of the first plurality of data blocks, wherein a size of the subset exceeds a product of the rate and a size of the first plurality of data blocks.

17. The system of claim 16, further comprising:
a recovery module operatively connected to the plurality of storage devices and configured to retrieve a second plurality of data blocks from the plurality of storage devices to recover the data item.

18. The system of claim 17, wherein a size of the second plurality of data blocks equals the product.

19. The system of claim 16, further comprising:
a key generation module operatively connected to the translation module and configured to generate an encryption key to encrypt the data item prior to translating the data item.

20. The system of claim 16, wherein each of the plurality of storage devices stores at most one data block of the subset.
